(19) United States
(12) Patent Application Publication
(10) Pub. No.: US 2019/0151971 A1
(43) Pub. Date: May 23, 2019

(54) TENSION CONTROL METHOD AND ELECTRICAL DISCHARGE MACHINING APPARATUS

(71) Applicant: Seibu Electric & Machinery Co., Ltd., Fukuoka (JP)

(72) Inventors: Yoshihiro ITO, Fukuoka (JP); Keisuke TASAKI, Fukuoka (JP); Takayasu SAKATANI, Fukuoka (JP); Takashi MITSUYASU, Fukuoka (JP)

(21) Appl. No.: 15/761,819

(22) PCT Filed: Aug. 25, 2017
(86) PCT No.: PCT/JP2017/030504

§ 371 Date: Mar. 21, 2018

(30) Foreign Application Priority Data
Nov. 10, 2016 (JP) 2016-219653

(51) Int. Cl. B23H 7/10; B23H 1/02; B23H 7/04

(52) U.S. Cl. CPC B23H 7/104; B23H 7/04; B23H 1/02

(57) ABSTRACT

A tension control method or the like is provided, configured to appropriately control a wire electrode, thereby providing high-precision machining compared with control using a tension detector with feedback control. An EDM apparatus includes a correspondence relation storage unit that stores a correspondence relation between a wire electrode tension between a feed roller and a winding roller and a speed difference between the feed motor and the winding motor or the like. A setting value storage unit stores user-set wire electrode setting values for the feed speed and tension. A determination unit determines the driving speed difference between the feed motor and the winding motor or the like based on the tension setting value, etc., with reference to the correspondence relation storage unit. A motor control unit controls the feed and winding motors using the feed speed setting value, the driving speed difference determined by the determination unit, etc.

### TECHNICAL FIELD

The present invention relates to a tension control method and an electrical discharge machining apparatus, and particularly to a tension control method or the like for controlling a tension applied to a wire electrode employed in an electrical discharge apparatus.

### BACKGROUND ART

An electrical discharge machining apparatus is an apparatus configured to provide electrical discharge machining using a wire electrode. By applying a suitable tension to the wire electrode, this arrangement is capable of providing high-precision machining.

With conventional techniques, as typically employed for such an electrical discharge machining apparatus, an arrangement is known in which a tension of the wire electrode is measured at a position between a feed roller arranged on the upstream side of the wire electrode and a winding roller arranged on the downstream side thereof using a tension detector. Furthermore, the rotational speed of each roller or the torque thereof is feedback controlled so as to provide the wire electrode with a suitable tension (see Patent document 1).

### CITATION LIST

### Patent Literature

### [Patent Document 1]

Japanese Patent Application Laid Open No. 2016-163923

### SUMMARY OF INVENTION

### Technical Problem

By employing a tension detector, a feedback control operation can be performed according to the tension in this stage.

However, the present inventors have found that such detection by means of the tension detector involves the occurrence of vibration in the wire electrode, which becomes a cause of degraded precision.

Furthermore, recently, the required precision has been raised. This requires such a feedback control operation to be performed with further improved precision in short cycles. As a result, for example, in many cases, this arrangement involves an undesired control operation that further increases vibration even though the vibration of the wire electrode is increasing. The present inventors have found that, as a result, such a feedback control operation becomes a cause of degraded precision.

With conventional techniques, the tension detector and the feedback control operation thereof involve no problem in precision. However, a high-precision control operation as currently required leads to an unprecedented problem in that the tension detector and the feedback control operation thereof become a cause of degraded precision. Accordingly, such a problem involving the tension detector and the feedback control operation thereof becoming a bottleneck in providing high precision is not generally known.

Accordingly, it is a purpose of the present invention to provide a tension control method or the like for appropriately controlling the tension of a wire electrode so as to provide high-precision machining as compared with a control operation by means of the tension detector and the feedback control operation thereof.

### Solution of Problem

A first aspect of the present invention relates to a tension control method for controlling a tension applied to a wire electrode employed in an electrical discharge apparatus. The electrical discharge machining apparatus comprises: a feed motor that drives a feed roller that feeds the wire electrode for electrical discharge machining; a winding motor that drives a winding roller that winds the wire electrode after electrical discharge machining; a correspondence relation storage unit that stores at least a correspondence relation between a difference in a driving speed between the feed motor and the winding motor and a tension that occurs in the wire electrode arranged between the feed roller and the winding roller; a setting value storage unit that stores a feed speed setting value and a tension setting value for the wire electrode; a determination unit that determines the difference in the driving speed between the feed motor and the winding motor; and a control unit that controls the feed motor and the winding motor. The tension control method comprises:

setting, in which the setting value storage unit stores the feed speed setting value and the tension setting value; determining, by means of the determination unit, the difference in the driving speed between the feed motor and the winding motor based on at least the tension setting value with reference to the correspondence relation storage unit; and controlling, by means of the control unit, the feed motor and the winding motor using the feed speed setting value and the difference in the driving speed determined by the determination unit.

A second aspect of the present invention relates to the tension control method according to the first aspect. The electrical discharge machining apparatus may comprise a calibration unit that calibrates a driving operation of the feed roller driven by the feed motor and a driving operation of the winding roller driven by the winding motor. Also, the tension control method may also comprise calibrating, by means of the calibration unit, the driving operation of the feed roller driven by the feed motor and the driving operation of the winding roller driven by the winding motor, so as to correct a difference between a correspondence relation stored in the correspondence relation storage unit between the difference in speed and the tension and a correspondence relation that has actually occurred between the difference in the driving speed between the feed motor and the winding motor and a tension of the wire electrode arranged between the feed roller and the winding roller.

A third aspect of the present invention relates to the tension control method according to the first or second aspect. In the aforementioned determination, the determination unit may determine the difference in speed between the feed motor and the winding motor based on the feed speed setting value and/or the diameter of the wire electrode, in addition to the tension setting value.

A fourth aspect of the present invention relates to the tension control method according to any one of the first aspect through the third aspect. The correspondence relation storage unit may store a correspondence relation between a torque of the feed motor and the tension that occurs in the wire electrode arranged between the feed roller and the winding roller, instead of the correspondence relation between the difference in speed between the feed motor and the winding motor and the tension. Also, the determination unit may determine the torque to be set for the feed motor. Also, in the aforementioned determination, the determination unit may determine the torque of the feed motor based on at least the tension setting value with reference to the correspondence relation storage unit. Also, in the aforementioned control, the control unit may control the feed motor and the winding motor using the feed speed setting value and the torque determined by the determination unit.

A fifth aspect of the present invention relates to an electrical discharge machining apparatus. The electrical discharge machining apparatus comprises: a feed motor that drives a feed roller that feeds a wire electrode for electrical discharge machining; a winding motor that drives a winding roller that winds the wire electrode after electrical discharge machining; a correspondence relation storage unit that stores a correspondence relation between a difference in a driving control operation between the feed motor and the winding motor and a tension that occurs in the wire electrode arranged between the feed roller and the winding roller; a setting value storage unit that stores a feed speed setting value and a tension setting value for the wire electrode; a determination unit that determines the difference in the driving control operation between the feed motor and the winding motor based on at least the tension setting value with reference to the correspondence relation storage unit; and a control unit that controls the feed motor and the winding motor using the feed speed setting value and the difference in the driving speed determined by the determination unit.

### Advantageous Effects of Invention

With each aspect of the present invention, a correspondence relation between the tension and the speed difference or the like is prepared beforehand. The speed difference or the like is acquired according to the tension setting value using the correspondence relation in order to control the rotational speeds or the like of the feed roller and the winding roller. Thus, this arrangement is capable of providing a high-precision tension control operation.

With each aspect of the present invention, this arrangement does not involve detection of a tension by means of a tension detector. Thus, such an arrangement has no problem of degradation in precision due to the tension detection. Also, this arrangement does not employ a feedback control operation. Such an arrangement has no problem of an increase in undesired vibration. Thus, this arrangement is capable of avoiding degradation in precision due to such undesired vibration.

It should be noted that, as described in Patent document 1, conventional techniques have been proposed under an implicit assumption that a complicated mechanism is required to provide a tension control operation for a wire electrode. Specifically, such conventional techniques have been proposed assuming that tension measurement is required. However, as specifically described with reference to FIG. 2, the present inventors have ascertained by experiment that the tension of the wire electrode can be controlled with high precision using the correspondence relation between the tension and the speed difference or the like determined beforehand.

However, even if the correspondence relation prepared beforehand initially matches the actual correspondence relation, a difference between them occurs due to electrical discharge machining or the like. With the second aspect of the present invention, the driving operations of the feed roller and the winding roller are calibrated such that the correspondence relation prepared beforehand matches the actual correspondence relation, thereby maintaining high precision. Such calibration may be performed by automatically performing measurement when the tension value is changed before machining. Also, such calibration may be periodically performed even if the tension value has not been changed.

Furthermore, with the third aspect of the present invention, the control operations of the feed roller and the winding roller are determined based on the diameter of the wire electrode (wire diameter), the feed speed setting value, etc., in addition to the tension setting value. This provides a high-precision tension control operation.

Furthermore, with the fourth aspect of the present invention, by performing the torque control operation, this arrangement provides a high-precision tension control operation in the same manner.

### BRIEF DESCRIPTION OF DRAWINGS

FIG. 1A is a block diagram showing a schematic configuration of an electrical discharge machining apparatus according to an embodiment of the present invention, and FIGS. 1B and 1C are flowcharts each showing an example of the operation thereof.

FIG. 2 is a graph showing measurement results of a tension and variation thereof measured using an actual apparatus.

### DESCRIPTION OF EMBODIMENTS

Description will be made below with reference to the drawings regarding an example of the present invention. It should be noted that an embodiment of the present invention is not restricted to the following example.

### Example

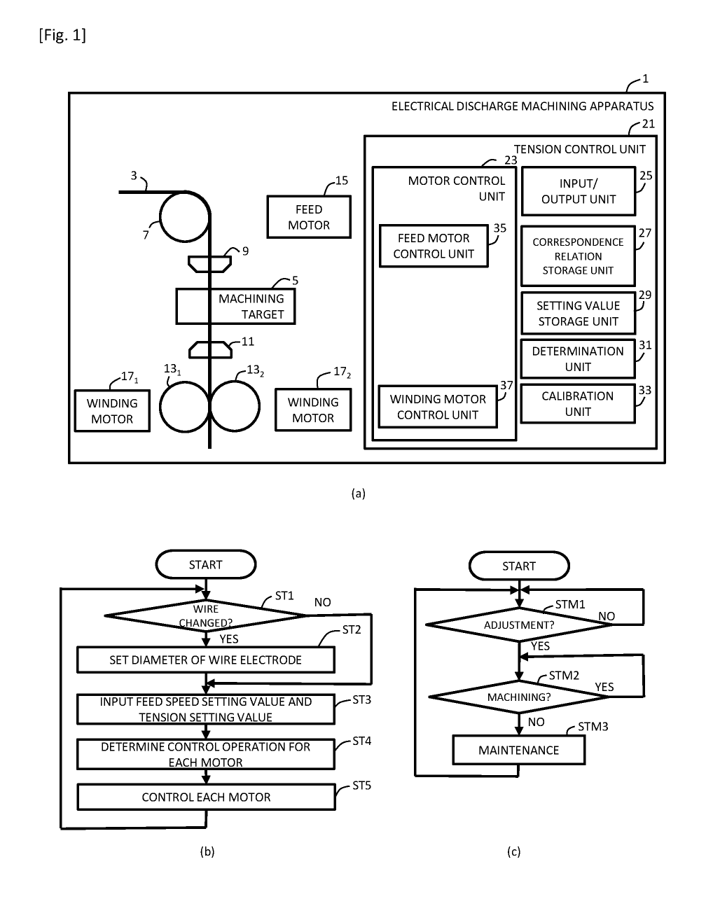

FIG. 1A is a block diagram showing a configuration of an electrical discharge machining apparatus according to an example of an embodiment of the present invention. FIGS. 1B and 1C are flowcharts each showing an example of the operation thereof.

Description will be made with reference to FIG. 1A regarding an example of the configuration of the electrical discharge machining apparatus 1. The electrical discharge machining apparatus 1 performs electrical discharge machining of a machining target 5 using a wire electrode 3.

The electrical discharge machining apparatus 1 includes: a wire electrode 3 (which is an example of a “wire electrode” in the claims of the present specification); a feed roller 7 (which is an example of a “feed roller” in the claims of the present specification); an upper head unit 9; a lower head unit 11; a winding roller 13 (which is an example of a “winding roller” in the claims of the present specification); a feed motor 15 (which is an example of a “feed motor” in the claims of the present specification); a winding motor 17 (which is an example of a “winding motor” in the claims of the present specification); and a tension control unit 21.

The tension control unit 21 includes: a motor control unit 23 (which is an example of a “control unit” in the claims of the present specification); an input/output unit 25; a correspondence relation storage unit 27 (which is an example of a “correspondence relation storage unit” in the claims of the present specification); a setting value storage unit 29 (which is an example of a “setting value storage unit” in the claims of the present specification); a determination unit 31 (which is an example of a “determination unit in the claims of the present specification); and a calibration unit 33 (which is an example of a “calibration unit” in the claims of the present specification). The motor control unit 23 includes a feed motor control unit 35 and a winding motor control unit 37.

The wire electrode 3 is wound around an unshown source bobbin. The wire electrode 3 is drawn from the source bobbin, and is discharged to the exterior via the feed roller 7, the upper head unit 9, the lower head unit 11, and the winding roller 13, in this order. The feed roller 7 and the upper head unit 9 are arranged on the upper side of the machining target 5. The lower head unit 11 and the winding roller 13 are arranged on the lower side of the machining target 5.

FIG. 1A shows an example in which a pair of winding roller units 13₁ and 13₂ are rotationally driven such that the wire electrode 3 is interposed between the rollers 13₁ and 13₂. It should be noted that such a feed roller 7 and a winding roller 13 may each be configured as a single roller unit. Also, such a feed roller 7 and a winding roller 13 may each be configured as a set of multiple roller units.

The feed motor 15 rotationally drives the feed roller 7. The winding motor 17 rotationally drives the winding roller 13. The feed speed at which the wire electrode is fed is adjusted by the rotational speeds of the feed roller 7 and the winding roller 13. Basically, the rotational speeds of the feed roller 7 and the winding roller 13 are determined by a feed speed setting value as described later. By providing a small difference in the speed between the feed speed provided by the feed roller 7 and the feed speed provided by the winding roller 13, the wire electrode 3 is provided with a tension. The tension control unit 21 determines the speed difference based on the tension setting value or the like, and controls the feed speeds provided by the feed roller 7 and the winding roller.

An excessively large tension of the wire electrode 3 leads to breakage of the wire electrode. Conversely, an excessively small tension thereof leads to poor machining precision. Accordingly, there is a need to apply a suitable tension. With conventional techniques, as a main purpose, attention is directed to only a function for generating a suitable tension. Thus, a simple control operation is performed. That is to say, a tension is measured, and the feedback control operation is performed with respect to the tension thus measured. However, the present inventors have found that the tension measurement and the feedback control operation lead to degradation in precision, which is an unprecedented problem. This becomes a cause of a bottleneck in providing high precision as recently required. The present invention proposes a technique for providing high-precision machining without involving tension measurement.

Description will be made with reference to FIGS. 1B and 1C regarding an example of the operation of the tension control unit 21.

Referring to FIG. 1B, the tension control unit 21 detects the diameter of the wire electrode, and judges whether or not a change has occurred in the diameter of the wire electrode (Step ST1). When judgment has been made that a change has occurred in the diameter of the wire electrode, the tension control unit 21 sets the wire electrode diameter stored in the setting value storage unit 29 to the diameter of the wire electrode in which a change has detected (Step ST2), following which the flow proceeds to Step ST3. When judgement has been made that a change has not occurred in the diameter of the wire electrode, the flow proceeds directly to Step ST3. The input/output unit 25 is configured to display information, and to allow the user to perform an operation so as to input information. For example, the input/output unit 25 is configured as a combination of a keyboard and a display or otherwise as a touch panel.

It should be noted that, for example, when a change in the diameter of the wire electrode has been detected, the input/output unit 25 may display a prompt to encourage the user to input the diameter. In this case, the user may input a new diameter value. Also, an arrangement may be made in which the wire electrode diameter is set to a user's setting value without detecting the diameter of the wire electrode.

The input/output unit 25 displays multiple items to be set by the user. These items include: an item for setting the feed speed at which the wire electrode is to be fed; and an item for setting the tension. This arrangement allows the user to operate the input/output unit 25 so as to input a feed speed setting value (which is an example of the “feed speed setting value” in the claims of the present specification) at which the wire electrode is to be fed, and a tension setting value (which is an example of the “tension setting value” in the claims of the present specification). In Step ST3, the tension control unit 29 instructs the setting value storage unit 29 to store the feed speed setting value and the tension setting value.

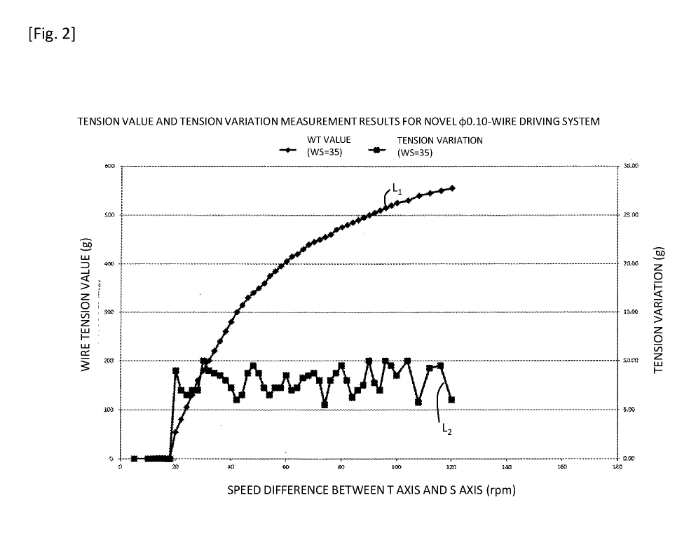

The correspondence relation storage unit 27 stores at least the correspondence relation between the driving speed difference between the feed motor 15 and the winding motor and the tension of the wire electrode 3 positioned between the feed roller 7 and the winding roller 13. For example, the correspondence relation represents a correspondence between the speed difference and the tension in a one-to-one manner as represented by the line L₁ shown in the graph in FIG. 2 in which the tension monotonically rises according to an increase in the speed difference.

The determination unit 31 acquires the speed difference that corresponds to the tension setting value based on the correspondence relation stored in the correspondence relation storage unit 27. With such an arrangement, for example, the rotational speeds of the feed motor 15 and the winding motor 17 are determined such that the feed speed provided by the winding roller 13 is set to the feed speed setting value, and such that the feed speed provided by the feed roller 7 is set to a value that is lower than the feed speed setting value by the speed difference thus acquired or the like (Step ST4). Subsequently, the feed motor control unit 35 and the winding motor control unit 37 respectively control the rotation of the feed motor 15 and the rotation of the winding motor 17 such that the feed speed provided by the feed roller 7 and the feed speed provided by the winding roller 13 respectively match the feed speeds determined by the determination unit 31 (step ST5). After the electrical discharge machining ends, the flow returns to Step ST1.

Referring to FIG. 1C, the calibration unit 33 judges whether or not a next adjustment timing has arrived after the previous adjustment timing (Step STM1). Examples of conditions based on which such judgment is made regarding whether or not a next adjustment timing has arrived include: a condition in which, when the tension value is changed before machining, a maintenance period of time has elapsed after the operation is started or otherwise after the adjustment has been made; a condition in which a machining maintenance period of time, which is a period of time in which the electrical discharge machining has been performed, has elapsed; and the like. It should be noted that the maintenance period of time and the machining maintenance period of time may be adjusted such that it is increased or otherwise reduced, based on various kinds of conditions such as the temperature. Before the next adjustment timing has arrived, this arrangement waits for the next adjustment timing. When the timing has arrived, the flow proceeds to Step STM2.

In Step STM2, judgment is made regarding whether or not electrical discharge machining is being performed (STM2). When the electrical discharge machining is being performed, this arrangement waits for the end of the electrical discharge machining. After the electrical discharge machining ends, the flow proceeds to Step STM3.

In Step STM3, the calibration unit 33 performs adjustment such that the correspondence relation between the difference in the feed speed between the feed roller 7 and the winding roller 13 and the tension that occurs between the feed roller 7 and the winding roller 13 matches the correspondence relation stored in the correspondence relation storage unit 27. Specifically, the tension and the speed difference are actually measured for two points (a first point on the low-tension side and a second point on the high-tension side). In the measurement for the first point (low-tension side), a tension setting value of 300 g is input, and the tension control unit controls the speed difference such that it becomes 45 rpm. In this state, the wire tension is actually measured. The measurement of the wire tension may be performed manually. Also, the measurement of the wire tension may be performed by means of an appropriate measurement unit. In the measurement for the second point (high-tension side), a tension setting value of 500 g is input, and the tension control unit controls the speed difference such that it becomes 90 rpm. In this state, the wire tension is actually measured. Subsequently, the L₁ curve shown in FIG. 2 is corrected based on the two-point data. That is to say, the intercept of the graph is corrected, and the slope of the graph is corrected, thereby performing correction of the L₁ curve. After this adjustment, the flow returns to Step STM1.

It should be noted that, in Step STM3, the calibration unit 33 may display a prompt to encourage the user to perform a maintenance operation. In this case, this arrangement may allow the user to operate the calibration unit 33 so as to perform adjustment such that the correspondence relation between the difference in speed between the feed roller 7 and the winding roller 13 and the tension that occurs between the feed roller 7 and the winding roller 13 matches the correspondence relation stored in the correspondence relation storage unit 27.

Also, the correspondence relation stored in the correspondence relation storage unit 27 and referred by the determination unit 31 may be a correspondence relation with the feed speed setting value, the diameter of the wire electrode, or the like, in stead of the tension setting value, for example.

Also, the tension of the wire electrode 3 may be generated using the torque of the feed motor 15, for example, instead of using the difference in the feed speed between the feed roller 7 and the winding roller 13. In this case, the correspondence relation storage unit 27 may preferably store the correspondence relation between the torque of the feed motor 15 and the tension of the wire electrode 3 positioned between the feed roller 7 and the winding roller 13. The determination unit 31 may preferably determine the torque of the feed motor 15 based on the tension setting value with reference to the correspondence relation storage unit 27. The motor control unit 23 may preferably control the feed motor 15 and the winding motor 17 using the feed speed setting value and the torque determined by the determination unit 31.

FIG. 2 is a graph showing measurement results performed using an actual apparatus. The diameter of the wire electrode was 0.10 [mm]. FIG. 2 shows the tension value (tension) and the variation of the tension (tension variation). The horizontal axis represents the difference in speed (rpm) between the T axis and the S axis (i.e., the difference in speed between the feed roller 7 and the winding roller 13). The line L₁ represents the values of the wire tension (g). The line L₂ represents the tension variation (g). It can be understood from the line L₁ that the tension is controlled as appropriate according to the speed difference. Also, it can be understood from the line L₂ that the tension variation is almost equal to or smaller than 10.00 g. In some cases, conventional control operations involve tension variation on the order of 20.00 (g). That is to say, this arrangement provides reduced variation in the tension.

### REFERENCE SIGNS LIST

1 electrical discharge machining apparatus, 3 wire electrode, 5 machining target, 7 feed roller, 9 upper head unit, 11 lower head unit, 13 winding roller, 15 feed motor, 17 winding motor, 21 tension control unit, 23 motor control unit, 25 input/output unit, 27 correspondence relation storage unit, 29 setting value storage unit, 31 determination unit, 33 calibration unit, 35 feed motor control unit, 37 winding motor control unit.

1. A tension control method for controlling a tension applied to a wire electrode employed in an electrical discharge apparatus, wherein the electrical discharge machining apparatus comprises:
a feed motor that drives a feed roller that feeds the wire electrode for electrical discharge machining;
a winding motor that drives a winding roller that winds the wire electrode after electrical discharge machining;
a correspondence relation storage unit that stores at least a correspondence relation between a difference in a driving speed between the feed motor and the winding motor and a tension that occurs in the wire electrode arranged between the feed roller and the winding roller;
a setting value storage unit that stores a feed speed setting value and a tension setting value for the wire electrode;
a determination unit that determines the difference in the driving speed between the feed motor and the winding motor; and
a control unit that controls the feed motor and the winding motor,
and wherein the tension control method comprises:
setting, in which the setting value storage unit stores the feed speed setting value and the tension setting value;
determining, by means of the determination unit, the difference in the driving speed between the feed motor and the winding motor based on at least the tension setting value with reference to the correspondence relation storage unit; and
controlling, in which the control unit determines a rotational speed of the feed motor and a rotational speed of the winding motor using the feed speed setting value and the difference in the driving speed determined by the determination unit, and rotationally drives the feed motor and the winding motor with the respective rotational speeds thus determined.

2. The tension control method according to claim 1, wherein the electrical discharge machining apparatus comprises a calibration unit that calibrates a driving operation of the feed roller driven by the feed motor and a driving operation of the winding roller driven by the winding motor when the tension setting value is changed,
and wherein the tension control method comprises calibrating, by means of the calibration unit, the driving operation of the feed roller driven by the feed motor and the driving operation of the winding roller driven by the winding motor, so as to correct a difference between a correspondence relation stored in the correspondence relation storage unit between the difference in speed and the tension and a correspondence relation that has actually occurred between the difference in the driving speed between the feed motor and the winding motor and a tension of the wire electrode arranged between the feed roller and the winding roller.

3. The tension control method according to claim 1, wherein, in the aforementioned determination, the determination unit determines the difference in speed between the feed motor and the winding motor based on the feed speed setting value and/or the diameter of the wire electrode, in addition to the tension setting value.

4. (canceled)

5. An electrical discharge machining apparatus comprising:
a feed motor that drives a feed roller that feeds a wire electrode for electrical discharge machining;
a winding motor that drives a winding roller that winds the wire electrode after electrical discharge machining;
a correspondence relation storage unit that stores a correspondence relation between a difference in a driving control operation between the feed motor and the winding motor and a tension that occurs in the wire electrode arranged between the feed roller and the winding roller;
a setting value storage unit that stores a feed speed setting value and a tension setting value for the wire electrode;
a determination unit that determines the difference in the driving control operation between the feed motor and the winding motor based on at least the tension setting value with reference to the correspondence relation storage unit; and
a control unit configured to determine a rotational speed of the feed motor and a rotational speed of the winding motor using the feed speed setting value and the difference in the driving speed determined by the determination unit, and to rotationally drive the feed motor and the winding motor with the respective rotational speeds thus determined.
